(19) United States
(12) Patent Application Publication
(10) Pub. No.: US 2026/0353121 A1
(43) Pub. Date: Nov. 5, 2026

(54) USER ACTIVITY DETECTION

(71) Applicant: Nokia Technologies Oy, Espoo (FI)

(72) Inventor: Haiyou GUO, Shanghai (CN)

(21) Appl. No.: 19/120,302

(22) PCT Filed: Oct. 17, 2022
(86) PCT No.: PCT/CN2022/125745

§ 371 Date: Apr. 11, 2025

(51) Int. Cl. H04W 24/08; H04L 27/26; H04W 56/00

(52) U.S. Cl. CPC H04W 24/08; H04L 27/2627; H04L 27/2646; H04W 56/0045

(57) ABSTRACT

Embodiments of the present disclosure relate to methods and apparatus for User Activity Detection (UAD). A terminal device receives, from a network device in the radio access network, a configuration associated with a set of subcarriers, wherein the set of subcarriers are associated with a set of terminal devices in the radio access network for transmission of modulated signals, the modulated signals being indicative of activity information of a set of active terminal devices out of the set of terminal devices; and transmits a modulated signal to the network device, wherein the modulated signal is generated by modulating a subcarrier from the set of subcarriers with a symbol and the modulated signal comprises a sparse Multicarrier Faster Than Nyquist (MC-FTN) signaling. In this way, a new solution for UAD for massive access with reduced latency and reduced cost of measurement resource is provided.

### FIELD

Various example embodiments relate to the field of telecommunication and in particular, to methods, devices, apparatuses and a computer readable storage medium for user activity detection.

### BACKGROUND

With the development of communication technologies, the future society will become digitalized and data-driven, for example through connected industries, intelligent transportation systems, smart cities, etc., thus providing greater convenience for daily life and industrial development. Machine Type Communication (MTC) is able to support massive connections, thus providing a possible approach to realize such a digitalized and data-driven society. Alongside, further development of the society will give rise to new and more stringent requirements on wireless connectivity. Enhancements on User Activity Detection (UAD) for MTC are still needed.

### SUMMARY

In general, example embodiments of the present disclosure provide a solution for performing user activity detection.

In a first aspect, there is provided a terminal device in a radio access network. The terminal device may comprise at least one processor and at least one memory storing instructions. The instructions, when executed by the at least one processor, cause the terminal device at least to: receive, from a network device in the radio access network, a configuration associated with a set of subcarriers, wherein the set of subcarriers are associated with a set of terminal devices in the radio access network for transmission of modulated signals, the modulated signals being indicative of activity information of a set of active terminal devices out of the set of terminal devices; and transmit, to the network device, a modulated signal, wherein the modulated signal is generated by modulating a subcarrier from the set of subcarriers with a symbol and the modulated signal comprises a sparse Multicarrier Faster Than Nyquist (MC-FTN) signaling.

In a second aspect, there is provided a network device in a radio access network. The network device may comprise at least one processor and at least one memory storing instructions. The instructions, when executed by the at least one processor, cause the terminal device at least to: transmit to a set of terminal devices in the radio access network, a configuration associated with a set of subcarriers, wherein the set of subcarriers are associated with the set of terminal devices for transmission of modulated signals, the modulated signals being indicative of activity information of a set of active terminal devices out of the set of terminal devices; receive a superimposed signal associated with the modulated signals from the set of active terminal devices, wherein the modulated signals are generated by modulating the set of subcarriers associated with the set of active terminal devices with a set of symbols corresponding to the set of active terminal devices, respectively, and comprise a sparse MC-FTN signaling; and identify the set of active terminal devices out of the set of terminal devices based on the received superimposed signal.

In a third aspect, there is provided a method. The method may comprise receiving, at a terminal device from a network device in a radio access network, a configuration associated with a set of subcarriers, wherein the set of subcarriers are associated with a set of terminal devices in the radio access network for transmission of modulated signals, the modulated signals being indicative of activity information of a set of active terminal devices out of the set of terminal devices; and transmitting, to the network device, a modulated signal, wherein the modulated signal is generated by modulating a subcarrier from the set of subcarriers with a symbol and the modulated signal comprises a sparse MC-FTN signaling.

In a fourth aspect, there is provided a method. The method may comprise transmitting, at a network device to a set of terminal devices in a radio access network, a configuration associated with a set of subcarriers, wherein the set of subcarriers are associated with the set of terminal devices for transmission of modulated signals, the modulated signals being indicative of activity information of a set of active terminal devices out of the set of terminal devices; receiving a superimposed signal associated with the modulated signals from the set of active terminal devices, wherein the modulated signals are generated by modulating the set of subcarriers associated with the set of active terminal devices with a set of symbols corresponding to the set of active terminal devices, respectively, and comprise a sparse MC-FTN signaling; and identifying the set of active terminal devices out of the set of terminal devices based on the received superimposed signal.

In a fifth aspect, there is provided an apparatus. The apparatus may comprise: means for receiving, at a terminal device from a network device in a radio access network, a configuration associated with a set of subcarriers, wherein the set of subcarriers are associated with a set of terminal devices in the radio access network for transmission of modulated signals, the modulated signals being indicative of activity information of a set of active terminal devices out of the set of terminal devices; and means for transmitting, to the network device, a modulated signal, wherein the modulated signal is generated by modulating a subcarrier from the set of subcarriers with a symbol and the modulated signal comprises a sparse MC-FTN signaling.

In a sixth aspect, there is provided an apparatus. The apparatus may comprise: means for transmitting, at a network device to a set of terminal devices in a radio access network, a configuration associated with a set of subcarriers, wherein the set of subcarriers are associated with the set of terminal devices for transmission of modulated signals, the modulated signals being indicative of activity information of a set of active terminal devices out of the set of terminal devices; means for receiving a superimposed signal associated with the modulated signals from the set of active terminal devices, wherein the modulated signals are generated by modulating the set of subcarriers associated with the set of active terminal devices with a set of symbols corresponding to the set of active terminal devices, respectively, and comprise a sparse MC-FTN signaling; and means for identifying the set of active terminal devices out of the set of terminal devices based on the received superimposed signal.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to: receive, from a network device in the radio access network, a configuration associated with a set of subcarriers, wherein the set of subcarriers are associated with a set of terminal devices in the radio access network for transmission of modulated signals, the modulated signals being indicative of activity information of a set of active terminal devices out of the set of terminal devices; and transmit, to the network device, a modulated signal, wherein the modulated signal is generated by modulating a subcarrier from the set of subcarriers with a symbol and the modulated signal comprises a sparse multicarrier Faster Than Nyquist MC-FTN signaling.

In a ninth aspect, there is provided a computer program comprising instructions, which, when executed by an apparatus, cause the apparatus at least to: transmit to a set of terminal devices in the radio access network, a configuration associated with a set of subcarriers, wherein the set of subcarriers are associated with the set of terminal devices for transmission of modulated signals, the modulated signals being indicative of activity information of a set of active terminal devices out of the set of terminal devices; receive a superimposed signal associated with the modulated signals from the set of active terminal devices, wherein the modulated signals are generated by modulating the set of subcarriers associated with the set of active terminal devices with a set of symbols corresponding to the set of active terminal devices, respectively, and comprise a sparse MC-FTN signaling; and identify the set of active terminal devices out of the set of terminal devices based on the received superimposed signal.

In a tenth aspect, there is provided a terminal device in a radio access network. The terminal device may comprise: receiving circuitry configured to receive, from a network device in the radio access network, a configuration associated with a set of subcarriers, wherein the set of subcarriers are associated with a set of terminal devices in the radio access network for transmission of modulated signals, the modulated signals being indicative of activity information of a set of active terminal devices out of the set of terminal devices; and transmitting circuitry configured to transmit, to the network device, a modulated signal, wherein the modulated signal is generated by modulating a subcarrier from the set of subcarriers with a symbol and the modulated signal comprises a sparse MC-FTN signaling.

In an eleventh aspect, there is provided a network device in a radio access network. The network device may comprise: transmitting circuitry configured to transmit, to a set of terminal devices in the radio access network, a configuration associated with a set of subcarriers, wherein the set of subcarriers are associated with the set of terminal devices for transmission of modulated signals, the modulated signals being indicative of activity information of a set of active terminal devices out of the set of terminal devices; receiving circuitry configured to receive a superimposed signal associated with the modulated signals from the set of active terminal devices, wherein the modulated signals are generated by modulating the set of subcarriers associated with the set of active terminal devices with a set of symbols corresponding to the set of active terminal devices, respectively, and comprise a sparse MC-FTN signaling; and identifying circuitry configured to identify the set of active terminal devices out of the set of terminal devices based on the received superimposed signal.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates a schematic diagram illustrating a process for communication according to some embodiments of the present disclosure;

FIG. 3A illustrates an example diagram of data signals and UAD signals in time domain according to some embodiments of the present disclosure;

FIG. 3B illustrates an example diagram of a multiplexing structure of data signals and UAD signals in frequency domain according to some embodiments of the present disclosure;

FIG. 4 illustrates an example diagram of a transmission procedure of an MC-FTN UAD signal according to some embodiments of the present disclosure;

FIG. 5 illustrates an example diagram of a procedure of generating a discrete-time baseband UAD signal according to some embodiments of the present disclosure;

FIG. 6 illustrates an example diagram of a reception procedure of superimposed MC-FTN UAD signals according to some embodiments of the present disclosure;

FIG. 7 illustrates an example implementation of a process for communication according to embodiments of the present disclosure;

FIG. 8 illustrates a performance comparison between synchronous UAD via MC-FTN signaling in accordance with some embodiments of the present disclosure and conventional Physical Layer Random Access Channel (PRACH) procedure via Zadoff-Chu (ZC) sequence under the same time-frequency resource;

FIG. 9 illustrates a flowchart of a method implemented at a terminal device according to some embodiments of the present disclosure;

FIG. 10 illustrates a flowchart of a method implemented at a network device according to some embodiments of the present disclosure;

FIG. 11 illustrates a simplified block diagram of an apparatus that is suitable for implementing embodiments of the present disclosure; and

FIG. 12 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G), or the further sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a Base Station (BS) or an Access Point (AP), for example, a Node B (NodeB or NB), an evolved NodeB (eNodeB or eNB), a NR NB (also referred to as a gNB), a Remote Radio Unit (RRU), a Radio Header (RH), a Remote Radio Head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, User Equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a Personal Digital Assistant (PDA), portable computers, desktop computer, image capture terminal devices such as digital cameras, gaming terminal devices, music storage and playback appliances, vehicle-mounted wireless terminal devices, wireless endpoints, mobile stations, Laptop-Embedded Equipment (LEE), Laptop-Mounted Equipment (LME), USB dongles, smart devices, wireless Customer-Premises Equipment (CPE), an Internet of Things (IoT) device, a watch or other wearable, a Head-Mounted Display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably. In the following description, the terms “preamble”, “sequence”, “waveform” and “signal” may be used interchangeably.

MTC in 5G is split into Ultra-Reliable and Low Latency Communications (URLLC) or critical MTC (cMTC) in controlled environments with small-payloads and low-data rates, and Massive MTC (mMTC) for large/dense deployments with sporadic traffic patterns. In the coming decade, owing to emerging industrial use cases and the verticalization of the service provision, these two domains will develop into several specialized subclasses, hence demanding multi-dimensional optimization and scalable designs. With the development of communication technology, evolved techniques are needed to serve highly diverse applications ranging from data-rate hungry holographic images and connected 360 XR (Augmented/Virtual/Mixed Reality) to massive access for various types of IoT devices. One of MTC service classes for 6G is proposed to be classified as scalable critical MTC (cMTC), which refers to supporting massive connectivity with high reliability and low latency, e.g. critical medical monitoring and factory automation. Scale and flexibility will continue to be important measures for 6G performance. 6G communication is expected to support as high connection density as 10 million devices per km².

As opposed to human-centric communications, machine-centric communications (e.g. scalable cMTC) generally possesses two distinctive features. On the one hand, the overall system needs to support massive connectivity—the number of terminal devices connected to a cellular network device may be in the order of 104 to 107. The macro network device prefers to provide a unified massive access for various types of IoT devices, offering a low-cost solution for supporting massive connectivity with high reliability and low latency. Commercially, the telecommunication vendors favor a unified solution. On the other hand, the traffic pattern is sporadic—at any given time only a small fraction of potential terminal devices are active. Typically, the machine-type terminal devices connect asynchronously and sporadically to a network device to send small data payloads. The sporadicity is due to the inherent burstiness of event-driven IoT communications in controlled and/or sensing environments. Most of the machine-type terminal devices make random requests independently, with less periodicity being able to be tracked and utilized. As such, it is impossible for the network device to predict when and which terminal device will deliver data packet in advance.

In 6G MTC, the massive terminal devices raise the sporadic but unpredictable scheduling request to ask for uplink resources from the uplink scheduler. Scheduling request is a flag indicating that a terminal device needs uplink resources for Uplink Shared Channel (UL-SCH) transmission, there are two ways to issue the flag in LTE and NR.

For a terminal device which has been configured with dedicated request resource, the scheduling request is usually transmitted on the Physical Uplink Control Channel (PUCCH) using preconfigured and periodically reoccurring PUCCH resources dedicated to the terminal device. Each terminal device is assigned dedicated PUCCH scheduling request resources with a periodicity ranging from every second OFDM symbol to support very latency-critical services up to every 80 ms for low overhead. However, such a resource configuration becomes unsustainable as connection density increases to 10 million devices per km², coming at unacceptable waste in spectrum. It is not wise to maintain the dedicated PUCCH simultaneously for the massive terminal devices with low traffic intensity.

For a terminal device which has not been configured with scheduling request resources, it relies on the random-access mechanism to request resources. This may be used to create a contention-based mechanism for requesting resources. However, the Physical Layer Random Access Channel (PRACH) mechanism imposes a limit on the number of active terminal devices that are granted to access the network device. For example, in a conventional four-step random access procedure, a terminal device randomly selects one sequence, out of 64 643-length Zadoff-Chu (ZC) sequences, and sends the selected sequence via 643 subcarriers that are shared by all random-access terminal devices. Such a design suffers many drawbacks, which prevent it from a practical solution to massive access. For example, due to limited number of preambles for PRACH, massive devices undertake random access by independently picking one sequence out of the same small set, inevitably causing serious collision, and incurring intolerable access delay. The repeating cycles of transmission-collision-retransmission also lead to an endless cascade of signaling exchange between the terminal device and network device. In addition, random preamble assignment in PRACH procedure not only causes performance degradation due to sequence collision, but also leads to an extra but necessary step for reporting the explicit user ID to network device. Moreover, the PRACH signaling is a standard multicarrier scheme following the Nyquist rule, where the symbol duration is necessary to be equal to the reciprocal of the subcarrier spacing. Such long symbol duration is an unavoidable penalty (budget) for access latency in conventional PRACH procedure.

Considering the unsustainable spectrum consumption and the low performance due to the lack of orthogonal preambles, both methods are unscalable and inapplicable to massive access with low traffic intensity.

In fact, in scenarios with massive number of potential devices but the limited coherence time and frequency dimensions in the wireless fading channel, it is impossible to assign orthogonal preambles to all terminal devices. However, non-orthogonal preamble set are superimposed and cause significant multi-user interference, e.g., when a simple matched filtering or correlation operation is applied at the network device, which makes the UAD much challenging. Therefore, a new solution to manage with the uncertain and random scheduling requests in a more efficient and effective way is needed.

To overcome the deficiencies in the conventional methods, the present disclosure provides a holistic design from waveform design and its transmission method at the terminal device side to the reception method at the network device side. Principle and example embodiments of the present disclosure will be described in detail below with reference to the accompanying drawings. However, it is to be noted that these embodiments are illustrated as examples and not intended to limit scope of the present application in any way.

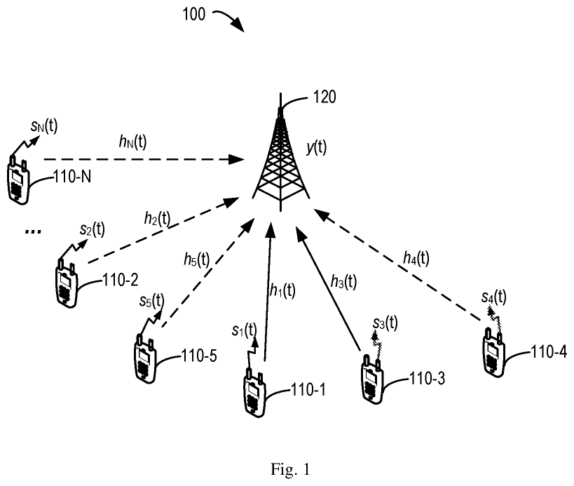

Reference is first made to FIG. 1, which illustrates an example communication network 100 in which embodiments of the present disclosure may be implemented. As illustrated in FIG. 1, the network 100 may include a network device 120. The network device 120 may provide a cellular network for massive access. As shown in FIG. 1, the network 100 may further include terminal devices 110-1, 110-2, 110-3, 110-4, 110-5, . . . , 110-N, which can be collectively referred to as “terminal device(s) 110”. The set of N terminal devices be denoted by S. The number N can be any suitable integer numbers. Without loss generality, N may be assumed to be an even and positive number. The terminal devices may be labelled by

$$n ∈ S = \{ - \frac{N}{2} , … , - 1 , 1 , … , \frac{N}{2} \} ,$$

respectively.

It is to be understood that, the number of network devices and terminal devices shown in FIG. 1 is only for the purpose of illustration without suggesting any limitations. The network 100 may include any suitable number of network devices and terminal devices adapted for implementing embodiments of the present disclosure.

In an example scenario, a small fraction of potential terminal devices, denoted by an active subset S_{A}⊆S, may become active and raise scheduling request for uplink data awaiting transmission at a given transmission instant or frame. For example, as shown in FIG. 1, the first terminal device 110-1 and the third terminal device 110-3 may be active while the second, fourth and fifth terminal devices 110-2, 110-4 and 110-5 are inactive.

The network device 120 may be configured to identify the active subset S_{A} out of entire set of terminal devices S through a UAD procedure, prior to building successful connections between the terminal devices and the network device. Once the network device 120 knows which terminal device has actual demand of data delivery at the beginning of one transmission cycle, the network device 120 may immediately assign the small number of active terminal devices with the scheduling grant so that the active terminal devices may further provide more detailed scheduling information to the network device 120. In this way the network device 120 is able to quickly know which terminal device has actual demand on data delivery at the beginning of one transmission cycle, thus a prompt response can be prepared for a successful communication.

For the purpose of illustration, without suggesting any limitation, each terminal device 110 may be equipped with single transmit antenna and the network device 120 may be assumed to be equipped with a single receive antenna. The impulse response of the UL multipath spread channel from terminal device n to the network device is denoted by hₙ(t). Suppose the N terminal devices have established a connection-like state through the initial access procedure. Except for the dedicated UL control channel for scheduling request, the terminal devices may have received the necessary system information, registered user identity (ID) and synchronized uplink timing, and obtained the prior knowledge of the corresponding UL channel, which allows for a synchronous UAD. The timing alignment information and channel state information (CSI) are assumed to be valid during the procedure of UAD, and are not outdated for static and low-mobility terminal devices. As such, the terminal devices may appropriately adjust their timing advance for UL transmissions, respectively, resulting in a synchronous UL transmission with respect to reception window at the network device 120.

To carry out synchronous UAD, in contrast to the conventional PRACH scheme with sequence collision, each terminal device 110 in the network 100 may be preassigned with a unique preamble used for all the time slots. This preamble may also serve as the ID for this terminal device. At each time slot, the network device 120 may detect active terminal devices by detecting which preambles are present.

As shown in FIG. 1, an active terminal device n∈S_{A}⊆S may send an exclusive preamble signal sₙ(t). The network device 120 may receive a synchronous and superimposed signal. A baseband version of the observed signal may be written as

$$y ( t ) = {\sum }_{n ∈ {S}_{A}} {s}_{n} ( t ) * {h}_{n} ( t ) + n ( t ) ,$$

where * denotes the operation of convolution and n(t) denotes additive noise including the inter-cell interference. For the UAD, the network device 120 is configured to identify the unknown active subset S_{A} based on its observation y(t).

Communications in the communication network 100 may be implemented according to any proper communication protocol(s), comprising, but not limited to, cellular communication protocols of the first generation (1G), the second generation (2G), the third generation (3G), the fourth generation (4G) and the fifth generation (5G) or beyond, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

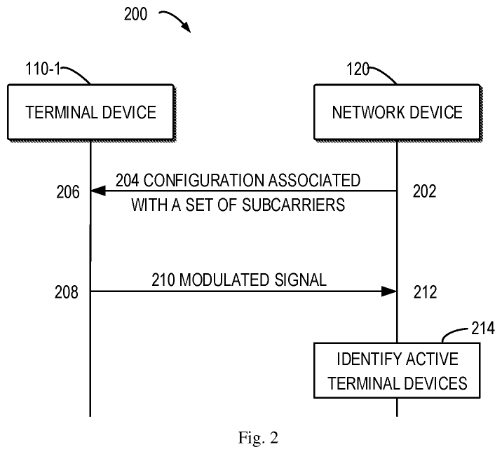

Reference is now made to FIG. 2, which illustrates a schematic diagram illustrating a process 200 for communication according to some embodiments of the present disclosure. For the purpose of discussion, the process 200 will be described with reference to FIG. 1. The network device 120 and the terminal device 110-1 may be involved in the process 200 for the purpose of illustration.

In the process 200, the network device 120 transmits 202 a configuration 204 associated with a set of subcarriers to the set of terminal devices S in the radio access network. The set of subcarriers are associated with the set of terminal devices S for transmission of modulated signals. The modulated signals are indicative of activity information of the set of active terminal devices S_{A} out of the set of terminal devices S. In some embodiments, based on the configuration 204, all potential terminal devices 110 in the set of terminal devices S may be assigned with a specific subcarrier. When any terminal device among the set of terminal devices S becomes active, e.g., when the terminal device has data awaiting transmission to the network device 120, the terminal device may transmit a preamble signal in a subcarrier associated with the terminal device.

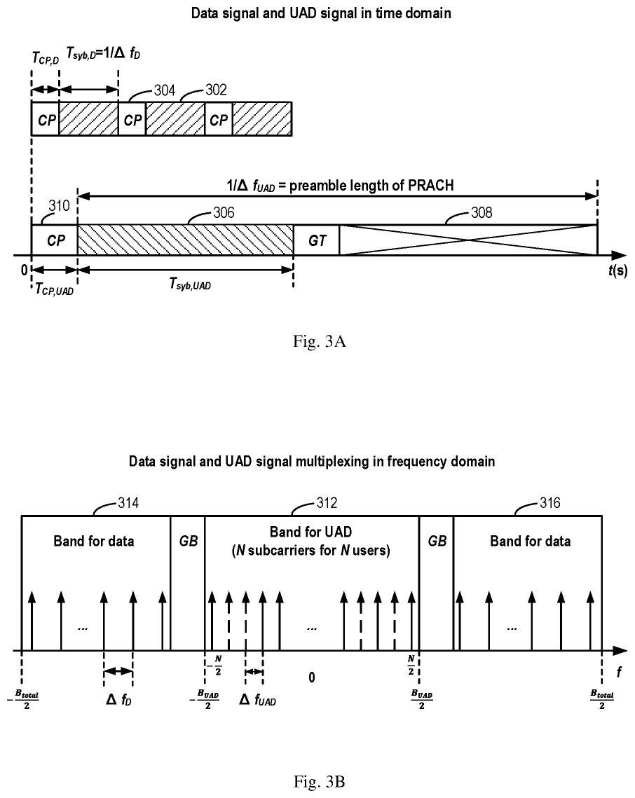

As shown in FIG. 2, the terminal device 110-1 receives 206 the configuration 204 and transmits 208 a modulated signal 210 to the network device 120. The modulated signal 210 is generated by modulating a subcarrier from the set of subcarriers with a symbol. The modulated signal 210 comprises a sparse MC-FTN signaling associated with {sₙ(t)}_{n∈S}, where the sparsity is caused by the sporadic transmission of the set of active terminal devices. The required time-frequency cost for the signal set {sₙ(t)}_{n∈S} may be evaluated in terms of Normalized Time-Bandwidth (NTB) product, i.e.,

$$NTB = \frac{1}{N} {\sum }_{n ∈ S} {T}_{n} {B}_{n} ,$$

where Bₙ and Tₙ are bandwidth and symbol time duration of preamble sₙ(t), respectively. The smaller the NTB product, the lower the time-frequency resource spent. Any orthogonal design requires adequate time-frequency resource such that NTB≥1. MC-FTN signaling allows for a shorter symbol time duration less than the reciprocal of the subcarrier spacing, resulting in a reduction in the unavoidable latency penalty. Meanwhile, the requirement NTB≤1 for MC-FTN signaling design indicates that the modulated signals {sₙ(t)}_{n∈S} from different terminal devices among the set of terminal devices S are non-orthogonal. Details of the MC-FTN signaling design will be described below in detail in connection with FIGS. 3A-5.

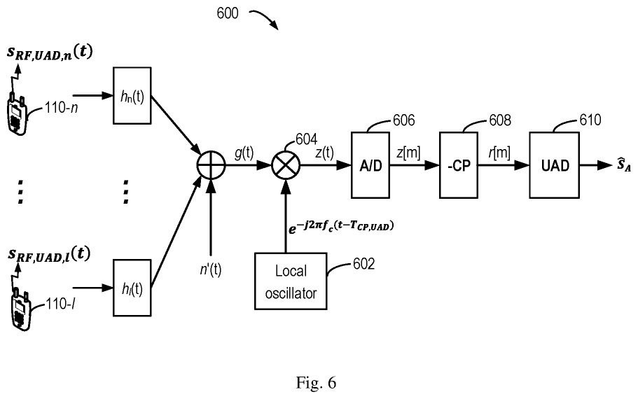

The network device 120 receives 212 the modulated signal 210 from the terminal device 110-1 and other modulated signals from other active terminal devices if any. From the perspective view of the network device 120, the network device 120 receives a superimposed signal, y(t), associated with the modulated signals from the set of active terminal devices S_{A}. The network device 120 identifies 214 the set of active terminal devices S_{A} out of the set of terminal devices S based on the received superimposed signal. In this way, a new solution for UAD for massive access with reduced latency and reduced cost of measurement resource is provided. Details of the identification procedure of the set of active terminal devices S_{A} will be described below in detail in connection with FIG. 6.

In some embodiments, the NTB product of the sparse MC-FTN signaling may be greater than or equal to a ratio of a number of the set of active terminal devices to a number of the set of terminal devices, that is

$$NTB \geq \frac{\vert {S}_{A} \vert}{N}$$

where |S_{A}| denotes the number of terminal devices being active at a given transmission instant or frame. In this way, the NTB product of the sparse MC-FTN signaling may be less than one and as small as the proportion of active terminal devices, no matter how the total number of devices scales up, thus providing in a scalable scheme for massive access with low measurement cost for UAD.

In some embodiments, the subcarrier may be associated exclusively with the terminal device. In this way, the fixed assignment of subcarriers establishes a unique association between preamble sets and terminal devices, which not only avoids the preamble collision due to random assignment, but also saves the additional procedure for reporting the user ID.

In some embodiments, in order to generate the subcarrier, the terminal device 110 may generate a complex sinusoid waveform with a frequency of the subcarrier. A time duration of the complex sinusoid waveform may be determined based on a reciprocal of a subcarrier spacing of the set of subcarriers, the number of the set of active terminal devices, and the number of the set of terminal devices. The terminal device may then add a cyclic prefix to the complex sinusoid waveform to generate the subcarrier. In this way, the required time-frequency resource for perfect detection may be merely dependent on the proportion of actual active terminal devices and unscalable with the total number of terminal devices N, resulting in a scalable scheme for massive access.

In some embodiments, the symbol may comprise a phase-compensation factor for compensating a phase of a channel between the network device and the terminal device in the subcarrier. Taking advantage of the precoding strategies based on phase compensation and sparse transmission over the frequency domain, the UAD problem may become a solvable linear inverse problem of nonnegative undetermined system. Based on the introduction of the phase-compensation factor, an effective sparse nonnegative vector may preserve the activity information of the corresponding active terminal devices. In the informative vector based on the mixed/superimposed observation, the components corresponding to the active terminal devices are strictly positive. Inactive terminal devices in the network may keep silent and the components corresponding to the inactive terminal devices are zeros. In this manner, the components corresponding to the active terminal devices can be solved from the mixed/superimposed observation.

In some embodiments, the terminal device 110 may generate a discrete-time baseband signal based on a baseband frequency of the subcarrier and the phase-compensation factor; generate a continuous-time baseband signal based on the discrete-time baseband signal, through a digital-to-analogue conversion procedure; and perform frequency shifting for the continuous-time baseband signal to generate the modulated signal. Different terminal devices may be discriminated by assigning distinct subcarriers without preamble collision.

In some embodiments, in order to generate the discrete-time baseband signal, the terminal device 110 may generate a first sequence modulated with the phase-compensation factor, by performing an Inverse Discrete Fourier transform (IDFT). A nonzero component of an input of the IDFT may comprise the symbol corresponding to the subcarrier. The terminal device 110 may then insert a copy of a last portion of the first sequence appended before the first sequence as a cyclic prefix to obtain a second sequence and discard a last portion of the second sequence to obtain the discrete-time baseband signal. A length of the discrete-time baseband signal excluding the cyclic prefix may be determined based on a time duration of the modulated signal and a sampling rate. With such definition of length, the perfect synchronous UAD can be made as long as the proportion of actual active UEs is less than the NTB product, thus minimum measurement cost required for perfect detection may be achieved. The designed signaling is a set of non-orthogonal complex sinusoid waveforms. Such well-designed waveform and the deliberate non-negativity transformation render the activity detection scheme more efficient and scalable. An MC-FTN signaling scheme for accurate, fast and scalable UAD is thus provided.

In some embodiments, in order to identify the set of active terminal devices S_{A}, the network device 120 may determine, based on the superimposed signal, a sparse nonnegative vector representing received symbols in the subcarriers associated with the set of terminal devices. The network device 120 may determine effective nonzero components of the received symbols by comparing the sparse nonnegative vector with a predefined threshold value. The network device 120 may then determine a set of identified active terminal devices Ŝ_{A} based on the effective nonzero components of the received symbols. In this way, the network device 120 may determine an estimate of active subset Ŝ_{A} by comparing the estimated nonnegative sparse vector with a threshold value. The careful design of transmission enables a fast and accurate detection method to derive the activity information from the noisy observation even for the FTN signaling.

In some embodiments, in order to determine the sparse nonnegative vector, the network device 120 may obtain a continuous-time baseband signal by performing frequency-shifting for the superimposed signal; convert the continuous-time baseband signal to a discrete-time baseband signal through an analogue-to-digital conversion; remove a cyclic prefix of the discrete-time baseband signal to obtain a superimposed complex sinusoid sequence; and estimate the sparse nonnegative vector by solving a nonnegative least square (NLS) problem based on the superimposed complex sinusoid sequence. The network device 120 first performs the standard processing as an OFDM receiver except for DFT. Then, the nonnegative sparse vector containing the activity information may be estimated by solving a NLS problem. In addition, non-negativity introduces the sparsity in a natural way. Thus, the regularization term (usually adopted by the compressive sensing) for encouraging sparsity can be avoided in the detection algorithm design, leading to a fast detection algorithm with finite-step computation. The NLS problem may be solved by the conventional active-set algorithm with finite steps, yielding a fast implementation without convergence concern.

In some embodiments, the network device 120 may transmit, to the set of terminal devices S, an indication indicative of a set of identified active terminal devices Ŝ_{A} through a common channel. The terminal device 110 may receive the indication from the network device 110 and determine whether it is included in the set of active terminal devices Ŝ_{A} identified by the network device 120. If the terminal device 110 is included in the set of active terminal devices Ŝ_{A} identified by the network device 120, the terminal device 110 may perform transmission with the network device 120. In some embodiments, the indication may be further indicative of resources for performing communication by the set of active terminal devices Ŝ_{A} respectively. The terminal device 110 may then perform the communication with the network device 120 using respective resource. For example, the terminal device 110 may further provide more detailed scheduling information, e.g., traffic-demand information or buffer status report, to the network device 120 using the respective resource indicated for the terminal device 110. If the terminal device 110 is excluded from the set of active terminal devices Ŝ_{A} identified by the network device 120, the terminal device 110 may retransmit a modulated signal to the network device 120. As a more efficient and effective method, the synchronous UAD procedure may be expected to replace PUCCH and PRACH procedure in the scheduling request-grant loop. The network device can quickly know which terminal device has actual demand on data delivery at the beginning of one transmission cycle, and a prompt response may be prepared for a successful communication.

In some embodiments, prior to the transmission of the modulated signal 210, the terminal device 110 may determine, based on timing alignment information, a timing advance for transmitting the modulated signal. In this way, a synchronous UL transmission with respect to reception window at the network device 120 may be achieved, thus enabling fast and accurate identification of the active terminal devices.

Reference is now made to FIGS. 3A-3B to illustrate example time-domain and frequency-domain structure of signals for conventional data transmission (i.e., data signals) and signals for UAD (i.e., UAD signals) according to some embodiments of the present disclosure, respectively. FIG. 3A illustrates an example diagram of data signals and UAD signals in time domain according to some embodiments of the present disclosure. FIG. 3B illustrates an example diagram of a multiplexing structure of data signals and UAD signals in frequency domain according to some embodiments of the present disclosure. As shown in FIGS. 3A and 3B, the system bandwidth configured for uplink transmission is Bₜₒₜₐₗ Hz. Data signal and UAD signal are multiplexed in the frequency domain, between which intended Guard Bands (GBs) are inserted to separate them. For the purpose of illustration, without suggesting any limitation, a continuous B_{UAD}-bandwidth band for UAD 312 is configured and located at central frequency, centered around the carrier frequency f_{c}. In some other examples, more than one bands for UAD may be configured and may not centered around the carrier frequency f_{c}. The data signal and UAD signal may use different subcarrier spacings Δf_{D} Hz and Δf_{UAD} Hz, respectively, in the frequency domain and different lengths in time domain. The data signal may comprise a Cyclic Prefix (CP) 304 and a data symbol 302 with a time duration of T_{CP,D} second and T_{syb,D} second, respectively. The UAD signal may comprise a CP 310 and a UAD symbol 306 with a time duration of T_{CP,UAD} second and T_{syb,UAD} second, respectively.

In some embodiments, the data signal may adopt the standard multicarrier design, e.g. Orthogonal Frequency-Division Multiple Access (OFDMA) or Single-carrier Frequency-Division Multiple Access (SC-FDMA) as in the legacy LTE/NR system. The data signal may adopt a wider subcarrier spacing Δf_{D} Hz, and the time duration T_{syb,D} of the data symbol 304 may be set according to Nyquist rule such that Δf_{D} T_{syb,D}=1. The data from different terminal devices may be multiplexed across different subset of subcarriers in the bands for data 314 and 316 according to scheduling grants from the network device 120. The time-domain and frequency-domain structure of data signal is illustrative for better understanding of the UAD signal. The present disclosure does not intend to provide any limitation on the design of data signals. Different structures of data signals may be designed.

In some embodiments, the band for UAD 312 may consist of N subcarriers for N terminal devices (i.e., N potential terminal devices) in the network 100 with a narrow and equal subcarrier spacing Δf_{UAD} Hz. A MC-FTN signaling for synchronous UAD is proposed such that Δf_{UAD} T_{syb,UAD}<1. Such MC-FTN design results in a shorter UAD symbol less than 1/Δf_{UAD}, reaping the benefits in resource saving and latency reduction. As shown in FIG. 3B, compared with the length of a preamble for PRACH following the Nyquist rule, the length of the UAD symbol 306 is shorten by a time reduction 308. In some embodiments, an intended Guard Time (GT) may be inserted to separate the UAD signal with other signals.

In some embodiments, a fixed association between terminal devices and subcarriers is provided. Each terminal device is assigned with a unique subcarrier so that the network device 120 may identify the active terminal devices by checking which subcarrier components are present in the superimposed signal that the network device receives. The association pattern is preassigned and known for the network device 120 and terminal devices 110, e.g., via an injective mapping between core-network/cell ID and subcarrier index. As a typical example, the terminal device

$$n ∈ S = \{ - \frac{N}{2} , … , - 1 , 1 , … , \frac{N}{2} \}$$

is assigned with an exclusive subcarrier of baseband frequency nΔf_{UAD}, where Direct Current (DC) subcarrier is not utilized in practice usually as it may be subject to disproportionally high interference due to local-oscillator leakage.

In the sparse MC-FTN transmission, only the active terminal devices n∈S_{A}⊆

$$S = \{ - \frac{N}{2} , … , - 1 , 1 , … , \frac{N}{2} \} ,$$

sends a symbol

$$\sqrt{{P}_{n}} \frac{{\hat{H}}_{n}^{*}}{‖ {\hat{H}}_{n} ‖}$$

in its associated subcarrier with frequency f_{c}+nΔf_{UAD}, indicated by the subcarriers shown in solid lines in the band for UAD 312, through a sparse MC-FTN signaling, where ∥·∥ denotes l₂-norm, the superscript (·)* denotes conjugation, Pₙ denotes the power factor for the terminal device n, and Ĥₙ denotes the estimate of channel coefficient between the network device and terminal device n in subcarrier f_{c}+nΔf_{UAD}, denoted by Hₙ. That is, the symbol

$$\sqrt{{P}_{n}} \frac{{\hat{H}}_{n}^{*}}{‖ {\hat{H}}_{n} ‖}$$

modulates the associated subcarrier

$${\{ {e}^{j 2 π ( {f}_{c} + n Δ {f}_{UAD} ) ( t - {T}_{Cp , UAD} )} \}}_{t = 0}^{{T}_{CP , UAD} + {T}_{Syb , UAD}}$$

where j=\sqrt{−1}, which is produced by generating a complex sinusoid waveform

$${\{ {e}^{i 2 π ( {f}_{c} + n Δ {f}_{UAD} ) t )} \}}_{t = 0}^{{T}_{Syb , UAD}}$$

with a frequency of f_{c}+nΔf_{UAD}, wherein a time duration of the complex sinusoid waveform T_{Syb,UAD} is determined based on a reciprocal of a subcarrier spacing of the set of subcarriers, i.e., Δf_{UAD}, the number of the set of active terminal devices, i.e., |S_{A}|, and the number of the set of terminal devices, i.e., N, where |·| denotes the cardinality of a set; and adding a cyclic prefix to the complex sinusoid waveform wherein the time duration of the cyclic prefix is T_{CP,UAD}. Thus, active terminal device n transmits a modulated signal that is a Radio Frequency (RF) UAD signal and may be written as Equation (1)

$${s}_{R F , U A D , n} ( t ) = \sqrt{{P}_{n}} \frac{{\hat{H}}_{n}^{*}}{‖ {\hat{H}}_{n} ‖} {e}^{i 2 π ( {f}_{c} + n Δ {f}_{UAD} ) ( t - {T}_{CP , UAD} )} , \qquad ( 1 )$$

$$0 \leq t < {T}_{C P , U A D} + {T}_{S y b , UAD} .$$

The modulated signals transmitted by all active terminal devices {s_{RF,UAD,n}(t)}_{n∈S}_{_{A}} comprises the sparse MC-FTN signaling.

In some embodiments, the modulated signal transmitted by active terminal device n can be described by a baseband signal which is a continuous-time baseband UAD symbol for user n written as Equation (2):

$${s}_{U A D , n} ( t ) = \sqrt{{P}_{n}} \frac{{\hat{H}}_{n}^{*}}{‖ {\hat{H}}_{n} ‖} {e}^{i 2 π n Δ {f}_{UAD} ( t - {T}_{CP , UAD} )} , \qquad ( 2 )$$

$$0 \leq t < {T}_{C P , U A D} + {T}_{s y b , U A D} ,$$

The adequate size of T_{CP,UAD} is comparable to the spread time of multipath channel for synchronous UAD. The symbol

$$\sqrt{{P}_{n}} \frac{{\hat{H}}_{n}^{*}}{‖ {\hat{H}}_{n} ‖}$$

comprises a phase-compensation factor

$$∡ \{ {\hat{H}}_{n}^{*} \}$$

for compensating a phase of Hₙ, i.e., ≮{Hₙ}, where ≮{·} denotes the angle of a complex number and Hₙ is the Fourier transform of the channel impulse response hₙ(t) at a frequency of f_{c}+nΔf_{UAD} corresponding to the active terminal device n∈S_{A}.

In some embodiments, to ensure the perfect UAD at network device 110, adequate time-frequency resource may be used such that the NTB product at least amounts to the proportion of actual active terminal devices, i.e.,

$$\frac{\vert {S}_{A} \vert}{N} \leq NTB = Δ {f}_{U A D} {T}_{s y m , U A D} < 1 .$$

In general, the user activity is sparse due to sporadic traffic, which means that

$$\frac{\vert {S}_{A} \vert}{N} ≪ 1$$

always holds and allows for Δf_{UAD} T_{sym,UAD}<1. Meanwhile, the inactive terminal devices remain silent in their associated subcarriers, indicated by the subcarriers shown in dotted lines in the band for UAD 312. Considering that the number of inactive terminal devices is much more than the number of active terminal devices, there is a sparse transmission over the frequency domain.

In some embodiments, the UAD signal is generated based on a desirable waveform

$${\{ {s}_{R F , U A D , n} ( t ) \}}_{t = 0}^{{T}_{CP , UAD} + {T}_{Syb , UAD}}$$

for accurate, fast and scalable user activity detection such that the required NTB product Δf_{UAD}T_{sym,UAD} may be as small as the average proportion of active terminal devices,

$$\frac{E \{ \vert {S}_{A} \vert \}}{N} ,$$

no matter how the total number of devices, N, scales up, where E{·} denotes the mathematical expectation. The waveform

$${\{ {s}_{R F , U A D , n} ( t ) \}}_{t = 0}^{{T}_{CP , UAD} + {T}_{Syb , UAD}}$$

is a complex sinusoid signal with constant modulus. Constant modulus is conducive to easing RF transmission for low-cost terminal devices. Taking advantage of the intended precoding strategy and sparsity in transmission, the user activity detection problem may be casted as a solvable linear inverse problem of nonnegative undetermined system. A sparse nonnegative vector preserves the activity information of the set of active terminal devices and can be solved from a mixed observation by the network device 110. For the sparse informative vector, the components corresponding to the active terminal devices are strictly positive while the components corresponding to inactive terminal devices are zeros. In essence, the precoding process based on a phase-compensation factor

$$∡ \{ {\hat{H}}_{n}^{*} \}$$

is introduced to compensate the phase of UL channels so that the activity information can be represented in terms of positive number, instead of a complex one, thus facilitating the UAD.

With such well-designed MC-FTN signaling and the deliberate non-negativity transformation, the user activity detection scheme is more efficient and scalable. Specifically, the holistic design in some embodiments of the present disclosure brings the following advantages:
1) Minimizing measurement cost required for UAD: Despite the NTB of the MC-FTN signaling is Δf_{UAD}T_{sym,UAD}<1, the synchronous UAD may be performed as long as the number of actual active terminal devices is less than NΔf_{UAD}T_{sym,UAD}.
2) Scalability for massive access: The required time-frequency resource for UAD is merely dependent on the proportion of actual active terminal devices and unscalable with the total number of terminal devices in the network, resulting in a scalable scheme.
3) Latency reduction: MC-FTN signaling allows for a short symbol duration less than the reciprocal of the subcarrier spacing (i.e., T_{sym,UAD}<1/Δf_{UAD}), resulting in a reduction in the unavoidable latency penalty.
4) Facilitating the sparsity detection: Non-negativity vector introduces the sparsity in a natural way. Thus, the regularization term (usually adopted by the compressive sensing) for encouraging sparsity can be avoided in the detection algorithm design, leading to a fast detection algorithm with finite-step computation.
5) Fixed assignment between preamble and terminal devices establishes a unique association, which not only avoids the preamble collision due to random assignment, but also saves the additional procedure for reporting the user ID.
6) Compatibility to the legacy LTE/NR: Both the transmission and reception procedures are compatible to the multicarrier scheme of LTE/NR, which can be readily integrated with the scheduling request-grant procedure for massive access, serving as a low-cost and high-performance solution.

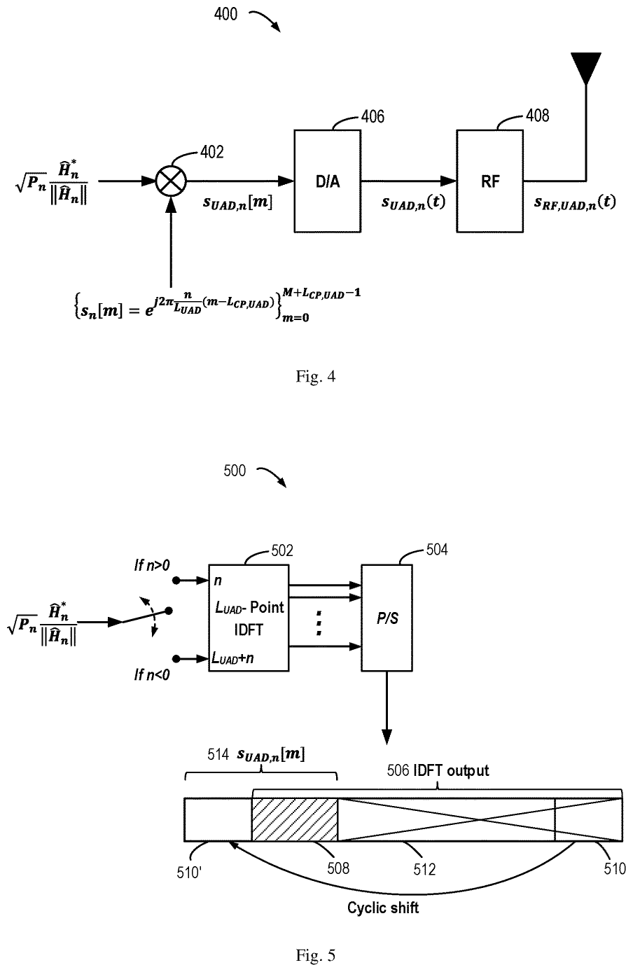

An example transmitter of MC-FTN signaling for synchronous UAD will be described in terms of waveform design and the related precoding strategy, with reference to FIG. 4, which illustrates an example diagram of a transmission procedure 400 of an MC-FTN UAD signal according to some embodiments of the present disclosure. For the purpose of discussion, the transmission procedure of the MC-FTN UAD signal will be described from the perspective of the terminal device with reference to FIG. 1 and the frequency domain structure shown in FIG. 3B.

As shown in FIG. 4, a terminal device

$$n ∈ \{ - \frac{N}{2} , … , - 1 , 1 , … , \frac{N}{2} \}$$

may be assigned with an exclusive subcarrier of f_{c}+nΔf_{UAD}. When the terminal device becomes active, a (M+L_{CP,UAD})-length complex sinusoid sequence may be generated according to the associated subcarrier frequency. The complex sinusoid sequence may be formulated as Equation (3):

$${\{ {s}_{n} [ m ] = {e}^{j 2 π \frac{n}{{L}_{UAD}} ( m - {L}_{CP , UAD} )} = {e}^{i 2 π n Δ {f}_{UAD} {T}_{s} ( m - {L}_{CP , UAD} )} \}}_{m = 0}^{M + {L}_{CP , UAD} - 1} , \qquad ( 3 )$$

where

$${L}_{U A D} = \frac{{B}_{total}}{Δ {f}_{UAD}} , {L}_{C P , U A D} = \frac{{T}_{CP , UAD}}{{T}_{s}} , M = \frac{{T}_{Syb , UAD}}{{T}_{s}} and {T}_{s} = \frac{1}{{B}_{total}}$$

denotes the corresponding sampling period.

As mentioned above, the terminal devices may have received the necessary system information, registered user identity (ID) and synchronized uplink timing, and obtained the prior knowledge of the corresponding UL channel. Based on the prior knowledge on the corresponding UL channel, the complex sinusoid sequence sₙ[m] may be modulated with a symbol

$$\sqrt{{P}_{n}} \frac{{\hat{H}}_{n}^{*}}{‖ {\hat{H}}_{n} ‖}$$

comprising a phase-compensation factor

$$∡ \{ {\hat{H}}_{n}^{*} \}$$

via a modulator 402. A discrete-time baseband UAD signal s_{UAD,n}[m] may be generated as Equation (4):

$${s}_{UAD , n} [ m ] = \sqrt{{P}_{n}} \frac{{\hat{H}}_{n}^{*}}{‖ {\hat{H}}_{n} ‖} {e}^{j 2 π \frac{n}{{L}_{UAD}} ( m - {L}_{CP , UAD} )} = \sqrt{{P}_{n}} \frac{{\hat{H}}_{n}^{*}}{‖ {\hat{H}}_{n} ‖} {e}^{j2 π n Δ {f}_{UAD} {T}_{s} ( m - {L}_{CP , UAD} )} , m = 0 , 1 , … , M + {L}_{CP , UAD} - 1. \qquad ( 4 )$$

The discrete-time baseband UAD signal s_{UAD,n}[m] may be converted to a continuous-time baseband UAD signal s_{UAD,n}(t) via a digital-to-analog (D/A) convertor 406. The D/A convertor 406 may work with the sampling period and

$${T}_{s} = \frac{ 1}{{B}_{t otal}}$$

and ensures s_{UAD,n}[m]=s_{UAD,n}(mTₛ). The continuous-time baseband UAD signal s_{UAD,n}(t) may be denoted as Equation (5):

$${s}_{UAD , n} ( t ) = \sqrt{{P}_{n}} \frac{{\hat{H}}_{n}^{*}}{‖ {\hat{H}}_{n} ‖} {e}^{j2 π n Δ {f}_{UAD} ( t - {T}_{CP , UAD} )} , 0 \leq t < {T}_{CP , UAD} + {T}_{Syb , UAD} . \qquad ( 5 )$$

The radio frequency (RF) module 408 may convert the baseband UAD signal s_{UAD,n}(t) to a RF UAD signal S_{RF,UAD,n}(t), written as Equation (1), for emission.

Alternatively, the discrete-time baseband UAD signal s_{UAD,n}[m] may be generated through an equivalent Inverse Discrete Fourier Transform (IDFT) structure. FIG. 5 illustrates an example diagram of a procedure 500 of generating the discrete-time baseband UAD signal s_{UAD,n}[m] according to some embodiments of the present disclosure As shown in FIG. 5, an L_{UAD}-point IDFT 502 is performed with a single nonzero input

$$\sqrt{{P}_{n}} \frac{{\hat{H}}_{n}^{*}}{‖ {\hat{H}}_{n} ‖} .$$

The input index may be determined according to the baseband frequency of the subcarrier the active terminal device

$$n ∈ \{ - \frac{N}{2} , … , - 1 , 1 , … , \frac{N}{2} \}$$

associates with. Ifn>0, the input index is n. If n<0, the input index is L_{UAD}+n. IDFT 502 may output the L_{UAD}-point samples. A parallel/serial (P/S) conversion 504 may be performed on the L_{UAD}-point samples to obtain the IDFT output 506. The last portion 510 of the IDFT output 506 with a length of L_{CP,UAD} points is copied and appended before the IDFT output 506 as a CP 510′ through cyclic shift. The last L_{UAD}-M points of the IDFT output 506 including the last two portions 510 and 512 may be discarded. The CP 510′ and the first M points 508 of the IDFT output 506 may form a (M+L_{CP,UAD})-length signal of s_{UAD,n}[m] for transmission. The CP 510′ and the first M points 508 may form the CP symbol 310 and the UAD symbol 306 of the UAD signal shown in FIG. 3, respectively. Obviously, the procedure 500 is compatible to the legacy multicarrier system such as LTE and NR.

In the transmission procedure, no coordination among the terminal devices is needed. Each terminal device behaves independently according to its own scheduling request or traffic demand, the inactive terminal devices refrain from any operations except for keeping silence. The network device 120 has the a priori knowledge on association pattern between the subcarriers and the terminal devices, so that the network device 120 may determine the active terminal devices by detecting which subcarrier components presents in its superimposed observation.

With the preamble design of the present disclosure, an accurate, fast, and scalable UAD at the minimum cost of measurement resource may be constructed. The good signaling design of {sₙ(t)}_{n∈S} may facilitate the whole process and promote the detection efficiency and performance. With some embodiments of the present disclosure, massive capacity, scalability and agility may be achieved. For example, a fixed preamble assignment may be allowed where each terminal device may be pre-assigned with a dedicated sequence beforehand. Instead of random preamble assignment, such a fixed assignment prevents the sequence collision. Any prior coordination in sequence assignment is in vain for random and distributed service requesting. Moreover, the unique association between sequence and users avoids the attached cost for reporting the user ID. The required time-frequency cost may be comparable to the (average) number of active terminal devices and irrelative to the population of massive terminal devices. The sparse MC-FTN signaling design enables the NTB product to be comparable to the proportion of active terminal devices with

$$NTB \approx \frac{E \{ \vert {S}_{A} \vert \}}{N} \leq 1 .$$

In addition, the sophisticated precoding to transfer the activity information is allowed and accurate and fast user activity detection at the network device is supported.

An example UAD method based on NLS will be described with reference to FIG. 6, which illustrates an example diagram of a reception procedure 600 of superimposed MC-FTN UAD signals according to some embodiments of the present disclosure. For the purpose of discussion, the reception procedure of the superimposed MC-FTN UAD signals will be described from the perspective of the network device with reference to FIG. 1 and the frequency domain structure shown in FIG. 3B.

As shown in FIG. 6, an active terminal device n∈S_{A} may send an exclusive RF UAD signal S_{RF,UAD,n}(t) to the network device 120. The network device 120 may receive a synchronous and superimposed signal g(t). Since the active terminal devices may adjust transmit-time advance according to the prior knowledge on timing alignment, the RF UAD signals from all active terminal devices may arrive at the network device 120 in a synchronous manner with respect to the receiving window of the network device 120. A synchronous and superimposed RF UAD signals received by the BS may be written as Equation (6):

$$g ( t ) = \{ \begin{matrix}aliasing CP component 1 & 0 \leq t < {T}_{CP , UAD} \\ \begin{matrix}{e}^{j 2 π {f}_{c} ( t - {T}_{CP , UAD} )} \\ {\sum }_{n ∈ {S}_{A}} {H}_{n} {s}_{UAD , n} ( t ) + {n}^{′} ( t )\end{matrix} & \begin{matrix}{T}_{CP , UAD} \leq t < \\ {T}_{CP , UAD} + {T}_{Syb , UAD}\end{matrix}\end{matrix} \qquad ( 6 )$$

where n′(t) stands for the additive noise. The network device 120 is configured to identify the unknown active subset S_{A} based on the received superimposed signal g(t).

In the reception procedure 600 for the synchronous UAD, the network device 120 may perform the standard processing as an OFDM receiver except for Discrete Fourier Transform (DFT) operation. In some embodiments, the network device 120 may convert 604 the received superimposed signal g(t) to a continuous-time baseband signal z(t) by using a local carrier signal e^{-j2πf}^{_{c}}^{(t-T}^{_{CP,UAD}}⁾ generated by a local oscillator 602. The continuous-time baseband signal z(t) may be written as Equation (7):

$$z ( t ) = g ( t ) {e}^{- j 2 π {f}_{c} ( t - {T}_{CP , UAD} )} = \{ \begin{matrix}aliasing CP component 2 & 0 \leq t \leq {T}_{CP , UAD} \\ {\sum }_{n ∈ {S}_{A}} {H}_{n} {s}_{UAD , n} [ t ] + {n}^{″} [ t ] & \begin{matrix}{T}_{CP , UAD} \leq t < \\ {T}_{CP , UAD} + {T}_{Syb , UAD}\end{matrix}\end{matrix} \qquad ( 7 )$$

where n″(t)=n′(t)e^{-j2πf}^{_{c}}^{(t-T}^{_{CP,UAD}}⁾.

The network device 120 may then convert 606 the continuous-time baseband signal z(t) to a (M+L_{CP,UAD})-length discrete-time baseband signal z[m] through A/D convertor that works with sampling period

$${T}_{s} = \frac{1}{{B}_{t otal}}$$

The discrete-time baseband signal z[m] may be written as Equation (8):

$$z [ m ] = z ( m {T}_{s} ) = \{ \begin{matrix}aliasing CP component 3 & m = 0 , 1 , … , {L}_{CP , UAD} - 1 \\ {\sum }_{n ∈ {S}_{A}} {H}_{n} {s}_{UAD , n} [ m ] + {n}^{″} [ m ] & \begin{matrix}m = {L}_{CP , UAD} , {L}_{CP , UAD} + \\ 1 , … , M + {L}_{CP , UAD} - 1\end{matrix}\end{matrix} \qquad ( 8 )$$

where n″[m]=n″ (mTₛ).

The network device 120 may then remove 608 the CP symbols composed of the first L_{CP,UAD}-point of the discrete-time baseband signal z[m], thus obtaining a M-length superimposed complex sinusoid sequence

$${\{ r [ m ] = z [ m + {L}_{CP , UAD} ] \}}_{m = 0}^{M - 1}$$

for synchronous UAD. The M-length sequence r[m] may be written as Equation (9):

$$r [ m ] = {\sum }_{n ∈ {S}_{A}} {α}_{n} {e}^{j 2 π \frac{n}{{L}_{UAD}} m} + n [ m ] , m = 0 , … , M - 1 , \qquad ( 9 )$$

where n[m]=n″[m+L_{CP,UAD}] and

$${α}_{n} = \sqrt{{P}_{n}} \frac{{\hat{H}}_{n}^{*} {H}_{n}}{‖ {\hat{H}}_{n} ‖}$$

denoting the symbol received in the subcarrier of f_{c}+nΔf_{UAD}. Both αₙ and Pₙ share the same indices of nonzero entries induced by the active terminal devices. The nonzero components can approximate to a positive number with help of the deliberate UL channel-phase compensation by

$$\frac{{\hat{H}}_{n}^{*}}{‖ {\hat{H}}_{n} ‖} .$$

Since Ĥₙ is an adequately exact estimate of Hₙ, αₙ may be written as Equation (10):

$${α}_{n} = \sqrt{{P}_{n}} \frac{{\hat{H}}_{n}^{*} {H}_{n}}{‖ {\hat{H}}_{n} ‖} = ‖ {H}_{n} ‖ \sqrt{{P}_{n}} {e}^{j ( ≮ \{ {\hat{H}}_{n}^{*} {H}_{n} \} )} \approx ‖ {H}_{n} ‖ \sqrt{{P}_{n}} \geq 0. \qquad ( 10 )$$

The component αₙ indicating an activity information of the terminal device n∈S may be positive for active terminal devices and zero for inactive terminal devices. Due to sporadic traffic, the vector

$${\{ {α}_{n} \}}_{n = - \frac{N}{2}}^{\frac{N}{2}}$$

is a sparse vector with only a few number of components that are corresponding to the active terminal devices are nonzero.

The network device 120 may then identify 610 the active subset S_{A} based on the M-length sequence

$${\{ r [ m ] \}}_{m = 0}^{M - 1}$$

by solving a NLS problem. The network device 120 tries to detect the active terminal devices in the active subset S_{A} by restoring N unknowns

$${\{ {α}_{n} \}}_{n = - \frac{N}{2}}^{\frac{N}{2}}$$

from M-length observations

$${\{ r [ m ] \}}_{m = 0}^{M - 1} .$$

The indices of nonzero components in

$${\{ {α}_{n} \}}_{n = - \frac{N}{2}}^{\frac{N}{2}}$$

are identical to those of the active terminal devices. This is an underdetermined linear system due to the MC-FTN design meeting

$$\frac{\vert {S}_{A} \vert}{N} \leq NTB = Δ {f}_{UAD} {T}_{sym , UAD} < 1 .$$

Without loss of generality, considering the case of Bₜₒₜₐₗ=B_{UAD}=NΔ_{UAD}, the length of the observation

$${\{ r [ m ] \}}_{m = 0}^{M - 1} is M = \frac{{T}_{Syb , UAD}}{{T}_{s}} = {T}_{Syb , UAD} N Δ {f}_{U A D} < N ,$$

meaning an underdetermined linear system with more unknown variables than equations. However, since

$${\{ {α}_{n} \}}_{n = - \frac{N}{2}}^{\frac{N}{2}}$$

is sparse with many zero entries, such a reconstruction problem is a sparse optimization problem that can be solved via convex technique.

For example, the network device 120 may estimate the nonnegative sparse vector

$${\{ {α}_{n} \}}_{n = - \frac{N}{2}}^{\frac{N}{2}}$$

containing the activity information by solving a nonnegative LS problem. The nonnegative LS problem may be solved by the conventional active-set algorithm with finite steps, yielding a fast implementation without convergence concern. An estimate of

$${\{ {α}_{n} \}}_{n = - \frac{N}{2}}^{\frac{N}{2}}$$

may be derived by Equation (11):

$${\{ {\hat{α}}_{n} \}}_{n = - \frac{N}{2}}^{\frac{N}{2}} = arg {min}_{{x}_{n} \geq 0 , n ∈ S} {\sum }_{m = 0}^{M - 1} {‖ r [ m ] - {\sum }_{n ∈ S} {x}_{n} {e}^{i 2 π \frac{n}{{L}_{UAD}} m} ‖}^{2} \qquad ( 11 )$$

The network device 120 may decide an estimate of active subset Ŝ_{A} by determining the effective nonzero components in the estimated nonnegative sparse vector

$${\{ {\hat{α}}_{n} \}}_{n = - \frac{N}{2}}^{\frac{N}{2}}$$

for eliminating the disturbance of observation error. For example, the effective nonzero components can be the components greater than a threshold. For example, the network device 120 may determine an active subset by Ŝ_{A}={n∈S|\hat{α}ₙ>β}, where β is a decision threshold to balance the miss-detection rate and false-alarm rate. In scenarios where the lower miss-detection rate is pursued, the decision threshold β may be decreased such that the number of active terminal devices in the identified active subset Ŝ_{A} is increased. In scenarios where the lower false-alarm rate is pursued, the decision threshold β may be increased such that the number of inactive terminal devices in the identified active subset Ŝ_{A} is decreased.

In some embodiments of the present disclosure, a channel-phase compensation strategy for MC-FTN signaling is proposed such that the unknown vector

$${\{ {α}_{n} \}}_{n = - \frac{N}{2}}^{\frac{N}{2}}$$

is restricted to be nonnegative. Thus, the system of r[m] turns out to be a nonnegative underdetermined system. Moreover, with the complex sinusoid sequences introduced by subcarrier assignment, the network device may capture entire information about the unknown vector

$${\{ {α}_{n} \}}_{n = - \frac{N}{2}}^{\frac{N}{2}}$$

with the minimum time-frequency resource. A fast and accurate detection method for the network device to recover the unknown vector

$${\{ {α}_{n} \}}_{n = - \frac{N}{2}}^{\frac{N}{2}}$$

from the noisy observation r[m] in the MC-FTN manner may thus be achieved.

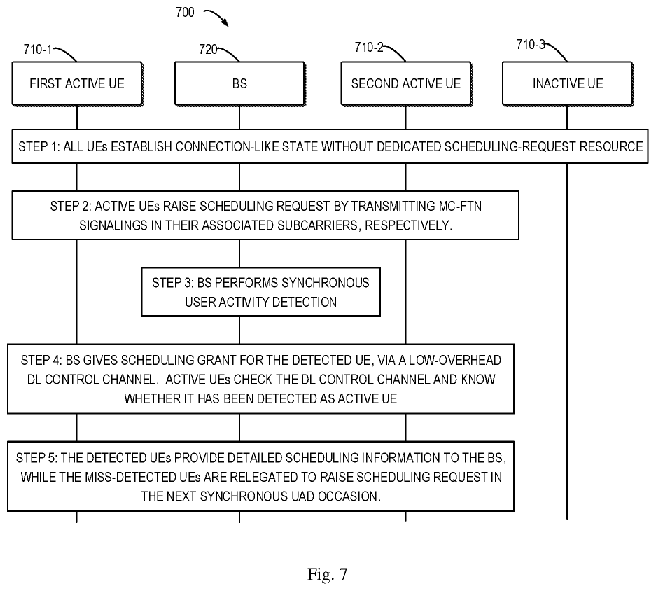

FIG. 7 illustrates an example implementation of a process 700 for communication according to embodiments of the present disclosure. It is noted that the process 700 can be considered as a more specific example of the process 200 of FIG. 2. The example implementation of FIG. 7 is depicted and will be described from perspectives of a first active UE 710-1, a second active UE 710-2, an inactive UE 710-3 and a BS 720.

All UEs in the network may establish a connection-like state without dedicated scheduling-request resource. The UEs may obtain synchronized uplink timing, which allows for a synchronous transmission of UAD signals. The UEs may also obtain the prior knowledge of the corresponding UL channels, allowing adequately exact estimate of channel coefficient of the terminal device.

At a given transmission instant or frame, UEs 710-1 and 710-2 may become active and raise scheduling request by transmit MC-FTN signaling in their associated subcarriers, respectively. The BS 720 may then perform synchronous user activity detection based on the received superimposed MC-FTN signaling. Based on the detected UEs, the BS 720 may provide scheduling grant for the detected UEs via a low-overhead DL control channel. Active UEs may check the DL control channel and know whether it has been detected as an active UE. The detected UEs may further provide detailed scheduling information to the BS 720, while the miss-detected UEs are relegated to raise scheduling request in the next synchronous UAD occasion. As an example, the scheduling information may comprise buffer status of the data to be transmitted to the BS 720 in the detected UEs, as another example, the scheduling information may request BS 720 to assign resource for the detected UE to transmit the data.

Although it is described in the example process 700 that active UEs transmit MC-FTN signaling for the scheduling request-grant procedure, the scope of the present disclosure is not limited in this regard. For example, the detected UEs may directly transmit data to the BS using the resource indicated by the BS, rather than transmitting a scheduling request first. The MC-FTN signaling may be transmitted by active terminal devices which wants to communicate with the network device but lacks uplink resources for the communication.

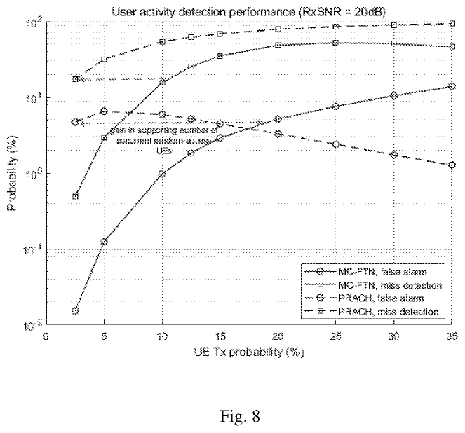

FIG. 8 illustrates a performance comparison between synchronous UAD (SUAD) via MC-FTN signaling in accordance with some embodiments of the present disclosure and conventional PRACH procedure via ZC sequence under the same time-frequency resource (0.8 ms×160 kHz). The NTB product of the MC-FTN signaling and ZC sequence are 0.125 and 1, respectively. Table 1 lists the detailed simulation parameters of the two procedures. For synchronous UAD, zero correlation zone of ZC sequence can be zero. This suggests that 131-length ZC sequence can provide 131 orthogonal sequences for synchronous terminal devices without ambiguity, which is more than the PRACH for random access without timing alignment.

TABLE 1
Simulation setup

| | SUAD via | PRACH via ZC |
|---|---|---|
| PARAMETER | MC-FTN | sequence |
| Bₜₒₜₐₗ: total system bandwidth (MHz) | 30.72 | |
| Tₛ: Sampling period (μs) | 0.033 | |
| R: Cell radius (m) | 500 | |
| Rx Signal to Noise Ratio after perfect | 20 | |
| power compensation (dB) | | |
| channel phase compensation | perfect | |
| symbol duration (ms) | 0.8 | |
| Length of time frame without GT (ms) | 0.9 | |
| CP length (ms) | 0.1 | |
| Total Number of potential UEs | 1024 | |
| Traffic pattern | Independent and identically distributed | |
| | transmission for all UEs | |
| Bandwidth for random access (kHz) | 160.0512 | 163.75 |
| Subcarrier spacing (kHz) | 0.1563 | 1.25 |
| NTB: Normalized time-bandwidth product | 0.125 | 1 |
| N_{ZC}: Length of ZC sequence | NA | 131 |
| N_{CS} − 1: Zero correlation zone of ZC | NA | 0 |
| sequence | | |
| Total number of usable orthogonal ZC | NA | 131 |
| sequences | | |

The UAD performance may be evaluated in terms of the probabilities of miss detection and false alarm. The simulation results are derived by averaging over 10000 independent experiments. FIG. 8 shows the UAD performance under different transmission probabilities. Curves of the MC-FTN signaling show a threshold of transmission probability of 12.5%, beyond which the detection performance degrades severely. The threshold amounts to the NTB product of the MC-FTN signaling in the simulation case. The simulation results in FIG. 8 show that the MC-FTN signaling can increase the supporting number of concurrent random-access terminal devices by above 4 times, compared to the existing PRACH scheme. Such a significant superiority is benefitted from the holistic design from the MC-FTN and collision-free waveform, non-negativity representation of activity information to the advanced detection method based on convex optimization technique. For PARCH, in contrast, sequence collision due to random selection remains the major cause to performance degradation.

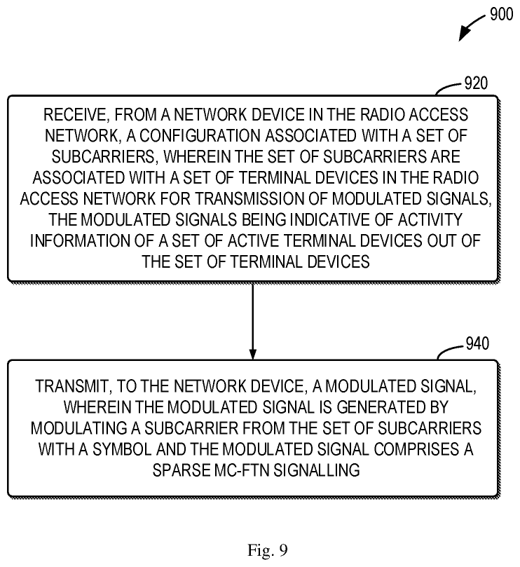

FIG. 9 illustrates a flowchart of a method 900 implemented at a terminal device according to some embodiments of the present disclosure. For example, the method 900 may be performed at the terminal device 110 (e.g., first terminal device 110-1) as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard. With the method 900 of FIG. 9, a new solution for UAD for massive access with reduced latency and reduced cost of measurement resource is provided.

At block 920, the terminal device 110 receives, from a network device 120 in the radio access network, a configuration associated with a set of subcarriers. The set of subcarriers are associated with a set of terminal devices in the radio access network for transmission of modulated signals. The modulated signals are indicative of activity information of a set of active terminal devices out of the set of terminal devices. At block 940, the terminal device 110 transmits, to the network device 120, a modulated signal, wherein the modulated signal is generated by modulating a subcarrier from the set of subcarriers with a symbol and the modulated signal comprises a sparse MC-FTN signaling.

In some embodiments, a normalized time bandwidth product of the sparse MC-FTN signaling may be greater than or equal to a ratio of a number of the set of active terminal devices to a number of the set of terminal devices. In some embodiments, the subcarrier may be associated exclusively with the terminal device 110.

In some embodiments, in order to generate the subcarrier, the terminal device 110 may generate a complex sinusoid waveform with a frequency of the subcarrier and add a cyclic prefix to the complex sinusoid waveform to generate the subcarrier. A time duration of the complex sinusoid waveform may be determined based on a reciprocal of a subcarrier spacing of the set of subcarriers, the number of the set of active terminal devices, and the number of the set of terminal devices.

In some embodiments, the symbol may comprise a phase-compensation factor for compensating a phase of a channel between the network device 120 and the terminal device 110 in the subcarrier.

In some embodiments, the terminal device 110 may generate a discrete-time baseband signal based on a baseband frequency of the subcarrier and the phase-compensation factor; generate a continuous-time baseband signal based on the discrete-time baseband signal, through a digital-to-analogue conversion procedure; and perform frequency shifting for the continuous-time baseband signal to generate the modulated signal.

In some embodiments, in order to generate the discrete-time baseband signal, the terminal device 110 may generate a first sequence modulated with the phase-compensation factor, by performing an Inverse Discrete Fourier transform (IDFT); insert a copy of a last portion of the first sequence appended before the first sequence as a cyclic prefix to obtain a second sequence; and discard a last portion of the second sequence to obtain the discrete-time baseband signal. A nonzero component of an input of the IDFT may comprise the symbol corresponding to the subcarrier. A length of the discrete-time baseband signal excluding the cyclic prefix may be determined based on a time duration of the modulated signal and a sampling rate.

In some embodiments, the terminal device 110 may receive, from the network device 120, an indication indicative of a set of active terminal devices identified by the network device 120; determine whether the terminal device 110 is included in the set of active terminal devices identified by the network device 120; and perform transmission with the network device 120 based on the determination that the terminal device 110 is included in the set of active terminal devices identified by the network device 120 or retransmit a modulated signal to the network device 120 based on the determination that the terminal device 110 is excluded from the set of active terminal devices identified by the network device 120.

In some embodiments, the indication may be indicative of resources for performing communication by the set of active terminal devices identified by the network device 120 respectively, and the terminal device 110 performs the communication with the network device 120 using respective resource. In some embodiments, the terminal device 110 may determine, based on timing alignment information, a timing advance for transmitting the modulated signal.

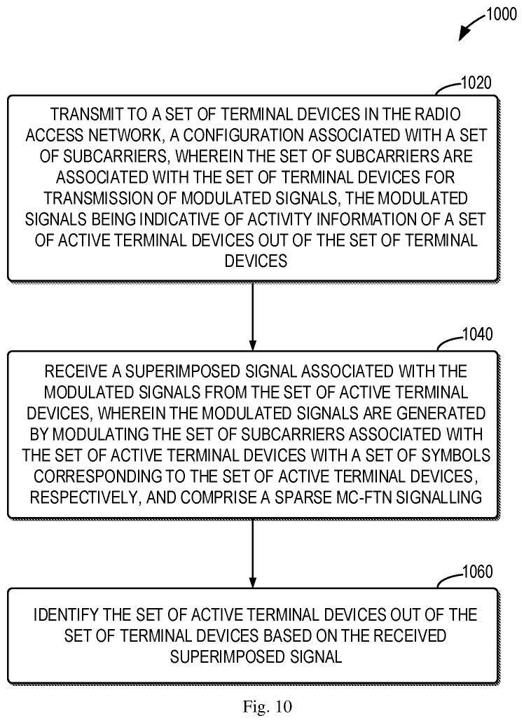

FIG. 10 illustrates a flowchart of a method 1000 implemented at a network device according to some embodiments of the present disclosure. For example, the method 1000 may be performed at the network device 120 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard. With the method 1000 of FIG. 10, a new solution for UAD for massive access with reduced latency and reduced cost of measurement resource is provided.

At block 1020, the network device 120 transmits to a set of terminal devices in the radio access network, a configuration associated with a set of subcarriers. The set of subcarriers are associated with the set of terminal devices for transmission of modulated signals. The modulated signals are indicative of activity information of the set of active terminal devices out of the set of terminal devices. At block 1040, the network device 120 receives a superimposed signal associated with the modulated signals from the set of active terminal devices. The modulated signals are generated by modulating the set of subcarriers associated with the set of active terminal devices with a set of symbols corresponding to the set of active terminal devices, respectively, and comprise a sparse MC-FTN signaling. At block 1040, the network device 120 identifies a set of active terminal devices out of the set of terminal devices based on the received superimposed signal.

In some embodiments, a normalized time bandwidth product of the sparse MC-FTN signaling may be greater than or equal to a ratio of a number of the set of active terminal devices to a number of the set of terminal devices.

In some embodiments, each of the set of symbols may comprise a phase-compensation factor for compensating a phase of a channel between the network device and corresponding active terminal device in the associated subcarrier.

In some embodiments, in order to identify the set of active terminal devices, the network device 120 may determine, based on the superimposed signal, a sparse nonnegative vector representing received symbols in the subcarriers associated with the set of terminal devices; determine effective nonzero components of the received symbols by comparing the sparse nonnegative vector with a predefined threshold value; and determine a set of identified active terminal devices based on the effective nonzero components of the received symbols.

In some embodiments, in order to determine the sparse nonnegative vector, the network device 120 may obtain a continuous-time baseband signal by performing frequency-shifting for the superimposed signal; convert the continuous-time baseband signal to a discrete-time baseband signal through an analogue-to-digital conversion; remove a cyclic prefix of the discrete-time baseband signal to obtain a superimposed complex sinusoid sequence; and estimate the sparse nonnegative vector by solving a nonnegative least square problem based on the superimposed complex sinusoid sequence.

In some embodiments, the network device 120 may transmit to the set of terminal devices an indication indicative of a set of identified active terminal devices through a common channel. In some embodiments, the indication may be indicative of resources for performing communication by each of the set of identified active terminal devices respectively.

In some embodiments, an apparatus capable of performing any of the method 900 (for example, the terminal device 110) may comprise means for performing the respective steps of the method 900. The means may be implemented in any suitable form. For example, the means may be implemented in a circuitry or software module.

In some embodiments, the apparatus comprises: means for receiving, at a terminal device from a network device in a radio access network, a configuration associated with a set of subcarriers, wherein the set of subcarriers are associated with a set of terminal devices in the radio access network for transmission of modulated signals, the modulated signals being indicative of activity information of a set of active terminal devices out of the set of terminal devices; and means for transmitting, to the network device, a modulated signal, wherein the modulated signal is generated by modulating a subcarrier from the set of subcarriers with a symbol and the modulated signal comprises a sparse MC-FTN signaling.

In some embodiments, a normalized time bandwidth product of the sparse MC-FTN signaling may be greater than or equal to a ratio of a number of the set of active terminal devices to a number of the set of terminal devices. In some embodiments, the subcarrier may be associated exclusively with the terminal device.

In some embodiments, means for generating the subcarrier may comprise means for generating a complex sinusoid waveform with a frequency of the subcarrier and means for adding a cyclic prefix to the complex sinusoid waveform to generate the subcarrier. A time duration of the complex sinusoid waveform may be determined based on a reciprocal of a subcarrier spacing of the set of subcarriers, the number of the set of active terminal devices, and the number of the set of terminal devices.

In some embodiments, the symbol may comprise a phase-compensation factor for compensating a phase of a channel between the network device and the terminal device in the subcarrier.

In some embodiments, the apparatus may further comprise means for generating a discrete-time baseband signal based on a baseband frequency of the subcarrier and the phase-compensation factor; means for generating a continuous-time baseband signal based on the discrete-time baseband signal, through a digital-to-analogue conversion procedure; and means for performing frequency shifting for the continuous-time baseband signal to generate the modulated signal.

In some embodiments, the means for generating the discrete-time baseband signal may comprise means for generating a first sequence modulated with the phase-compensation factor, by performing an Inverse Discrete Fourier transform (IDFT); means for inserting a copy of a last portion of the first sequence appended before the first sequence as a cyclic prefix to obtain a second sequence; and means for discarding a last portion of the second sequence to obtain the discrete-time baseband signal. A nonzero component of an input of the IDFT may comprise the symbol corresponding to the subcarrier. A length of the discrete-time baseband signal excluding the cyclic prefix may be determined based on a time duration of the modulated signal and a sampling rate.

In some embodiments, the apparatus may further comprise means for receiving, from the network device, an indication indicative of a set of active terminal devices identified by the network device; means for determining whether the terminal device is included in the set of active terminal devices identified by the network device; and means for performing transmission with the network device based on the determination that the terminal device is included in the set of active terminal devices identified by the network device or retransmitting a modulated signal to the network device based on the determination that the terminal device is excluded from the set of active terminal devices identified by the network device.

In some embodiments, the indication may be indicative of resources for performing communication by the set of active terminal devices identified by the network device respectively. The apparatus may further comprise means for performing the communication with the network device using respective resource. In some embodiments, the apparatus may further comprise means for determining, based on timing alignment information, a timing advance for transmitting the modulated signal.

In some embodiments, the apparatus further comprises means for performing other steps in some embodiments of the method 900. In some embodiments, the means comprises at least one processor and at least one memory including computer program code, the at least one memory and computer program code configured to, with the at least one processor, cause the performance of the apparatus.

In some embodiments, an apparatus capable of performing any of the method 1000 (for example, the network device 120) may comprise means for performing the respective steps of the method 1000. The means may be implemented in any suitable form. For example, the means may be implemented in a circuitry or software module.

In some embodiments, the apparatus comprises: means for transmitting to a set of terminal devices in the radio access network, a configuration associated with a set of subcarriers, wherein the set of subcarriers are associated with the set of terminal devices for transmission of modulated signals, the modulated signals being indicative of activity information of the set of active terminal devices out of the set of terminal devices; means for receiving a superimposed signal associated with the modulated signals from the set of active terminal devices, wherein the modulated signals are generated by modulating the set of subcarriers associated with the set of active terminal devices with a set of symbols corresponding to the set of active terminal devices, respectively, and comprise a sparse MC-FTN signaling; and means for identifying a set of active terminal devices out of the set of terminal devices based on the received superimposed signal.

In some embodiments, a normalized time bandwidth product of the sparse MC-FTN signaling may be greater than or equal to a ratio of a number of the set of active terminal devices to a number of the set of terminal devices.

In some embodiments, each of the set of symbols may comprise a phase-compensation factor for compensating a phase of a channel between the network device and corresponding active terminal device in the associated subcarrier.

In some embodiments, the means for identifying the set of active terminal devices may comprise means for determining, based on the superimposed signal, a sparse nonnegative vector representing received symbols in the subcarriers associated with the set of terminal devices; means for determining effective nonzero components of the received symbols by comparing the sparse nonnegative vector with a predefined threshold value; and means for determining a set of identified active terminal devices based on the effective nonzero components of the received symbols.

In some embodiments, the means for determining the sparse nonnegative vector may comprise means for obtaining a continuous-time baseband signal by performing frequency-shifting for the superimposed signal; means for converting the continuous-time baseband signal to a discrete-time baseband signal through an analogue-to-digital conversion; means for removing a cyclic prefix of the discrete-time baseband signal to obtain a superimposed complex sinusoid sequence; and means for estimating the sparse nonnegative vector by solving a nonnegative least square problem based on the superimposed complex sinusoid sequence.

In some embodiments, the apparatus may further comprise means for transmitting to the set of terminal devices an indication indicative of a set of identified active terminal devices through a common channel. In some embodiments, the indication may be indicative of resources for performing communication by each of the set of identified active terminal devices respectively.

In some embodiments, the apparatus further comprises means for performing other steps in some embodiments of the method 1000. In some embodiments, the means comprises at least one processor and at least one memory including computer program code, the at least one memory and computer program code configured to, with the at least one processor, cause the performance of the apparatus.

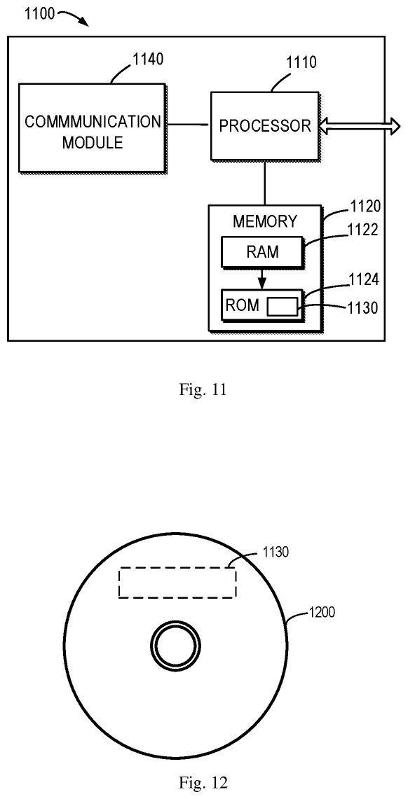

FIG. 11 is a simplified block diagram of a device 1100 that is suitable for implementing embodiments of the present disclosure. The device 1100 may be provided to implement the communication device, for example the terminal device 110, or the network device 120 as shown in FIG. 1. As shown, the device 1100 includes one or more processors 1110, one or more memories 1140 coupled to the processor 1110, and one or more communication modules 1140 coupled to the processor 1110.

The communication module 1140 is for bidirectional communications. The communication module 1140 has at least one antenna to facilitate communication. The communication interface may represent any interface that is necessary for communication with other network elements.

The processor 1110 may be of any type suitable to the local technical network and may include one or more of the following: general purpose computers, special purpose computers, microprocessors, Digital Signal Processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an Electrically Programmable Read Only Memory (EPROM), a flash memory, a hard disk, a Compact Disc (CD), a Digital Video Disk (DVD), and other magnetic storage and/or optical storage. Examples of the volatile memories include, but are not limited to, a Random Access Memory (RAM) 1122 and other volatile memories that will not last in the power-down duration.

A computer program 1130 includes computer executable instructions that are executed by the associated processor 1110. The program 1130 may be stored in the ROM 1124. The processor 1110 may perform any suitable actions and processing by loading the program 1130 into the RAM 1122.

The embodiments of the present disclosure may be implemented by means of the program 1130 so that the device 1100 may perform any process of the disclosure as discussed with reference to FIGS. 1 to 8. The embodiments of the present disclosure may also be implemented by hardware or by a combination of software and hardware.

In some embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. The computer readable medium may include any types of tangible non-volatile storage, such as ROM, EPROM, a flash memory, a hard disk, CD, DVD, and the like. FIG. 12 shows an example of the computer readable medium 1200 in form of CD or DVD. The computer readable medium has the program 1130 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 900 or 1000 as described above with reference to FIGS. 1-8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a Random Access Memory (RAM), a Read-Only Memory (ROM), an Erasable Programmable Read-Only Memory (EPROM or Flash memory), an optical fiber, a portable Compact Disc Read-Only Memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device in a radio access network comprising:
at least one processor; and
at least one memory storing instructions that, when executed by the at least one processor, cause the terminal device at least to:
receive, from a network device in the radio access network, a configuration associated with a set of subcarriers, wherein the set of subcarriers are associated with a set of terminal devices in the radio access network for transmission of modulated signals, the modulated signals being indicative of activity information of a set of active terminal devices out of the set of terminal devices; and
transmit, to the network device, a modulated signal, wherein the modulated signal is generated by modulating a subcarrier from the set of subcarriers with a symbol and the modulated signal comprises a sparse Multicarrier Faster Than Nyquist (MC-FTN) signaling.

2. The terminal device of claim 1, wherein a normalized time bandwidth product of the sparse MC-FTN signaling is greater than or equal to a ratio of a number of the set of active terminal devices to a number of the set of terminal devices.

3. The terminal device of claim 1, wherein the subcarrier is associated exclusively with the terminal device.

4. The terminal device of claim 1, wherein the terminal device is caused to generate the subcarrier by:
generating a complex sinusoid waveform with a frequency of the subcarrier, wherein a time duration of the complex sinusoid waveform is determined based on a reciprocal of a subcarrier spacing of the set of subcarriers, the number of the set of active terminal devices, and the number of the set of terminal devices; and
adding a cyclic prefix to the complex sinusoid waveform.

5. The terminal device of claim 1, wherein the symbol comprises a phase-compensation factor for compensating a phase of a channel between the network device and the terminal device in the subcarrier.

6. The terminal device of claim 5, wherein the terminal device is further caused to:
generate a discrete-time baseband signal based on a baseband frequency of the subcarrier and the phase-compensation factor;
generate a continuous-time baseband signal based on the discrete-time baseband signal, through a digital-to-analogue conversion procedure; and
perform frequency shifting for the continuous-time baseband signal to generate the modulated signal.

7. The terminal device of claim 6, wherein the terminal device is caused to generate the discrete-time baseband signal by:
generating a first sequence modulated with the phase-compensation factor, by performing an Inverse Discrete Fourier transform (IDFT), wherein a nonzero component of an input of the IDFT comprises the symbol corresponding to the subcarrier;
inserting a copy of a last portion of the first sequence appended before the first sequence as a cyclic prefix to obtain a second sequence; and
discarding a last portion of the second sequence to obtain the discrete-time baseband signal, wherein a length of the discrete-time baseband signal excluding the cyclic prefix is determined based on a time duration of the modulated signal and a sampling rate.

8. The terminal device of claim 1, wherein the terminal device is further caused to:
receive, from the network device, an indication indicative of a set of active terminal devices identified by the network device;
determine whether the terminal device is included in the set of active terminal devices identified by the network device; and
perform transmission with the network device based on the determination that the terminal device is included in the set of active terminal devices identified by the network device or retransmit a modulated signal to the network device based on the determination that the terminal device is excluded from the set of active terminal devices identified by the network device.

9. The terminal device of claim 8, wherein the indication is indicative of resources for performing communication by the set of active terminal devices identified by the network device respectively, and the terminal device performs the communication with the network device using respective resource.

10. The terminal device of claim 1, wherein the terminal device is further caused to:
determine, based on timing alignment information, a timing advance for transmitting the modulated signal.

11. A network device in a radio access network comprising:
at least one processor; and
at least one memory storing instructions that, when executed by the at least one processor, cause the network device at least to:
transmit to a set of terminal devices in the radio access network, a configuration associated with a set of subcarriers, wherein the set of subcarriers are associated with the set of terminal devices for transmission of modulated signals, the modulated signals being indicative of activity information of a set of active terminal devices out of the set of terminal devices;
receive a superimposed signal associated with the modulated signals from the set of active terminal devices, wherein the modulated signals are generated by modulating the set of subcarriers associated with the set of active terminal devices with a set of symbols corresponding to the set of active terminal devices, respectively, and comprise a sparse Multicarrier Faster Than Nyquist (MC-FTN) signaling; and
identify the set of active terminal devices out of the set of terminal devices based on the received superimposed signal.

12. The network device of claim 11, wherein a normalized time bandwidth product of the sparse MC-FTN signaling is greater than or equal to a ratio of a number of the set of active terminal devices to a number of the set of terminal devices.

13. The network device of claim 11, wherein each of the set of symbols comprises a phase-compensation factor for compensating a phase of a channel between the network device and corresponding active terminal device in the associated subcarrier.

14. The network device of claim 11, wherein the network device is caused to identify the set of active terminal devices by:
determining, based on the superimposed signal, a sparse nonnegative vector representing received symbols in the subcarriers associated with the set of terminal devices;
determining effective nonzero components of the received symbols by comparing the sparse nonnegative vector with a predefined threshold value; and
determining a set of identified active terminal devices based on the effective nonzero components of the received symbols.

15. The network device of claim 14, wherein the network device is caused to determine the sparse nonnegative vector by:
obtaining a continuous-time baseband signal by performing frequency-shifting for the superimposed signal;
converting the continuous-time baseband signal to a discrete-time baseband signal through an analogue-to-digital conversion;
removing a cyclic prefix of the discrete-time baseband signal to obtain a superimposed complex sinusoid sequence; and
estimating the sparse nonnegative vector by solving a nonnegative least square problem based on the superimposed complex sinusoid sequence.

16. The network device of claim 11, wherein the network device is further caused to:
transmit to the set of terminal devices an indication indicative of a set of identified active terminal devices through a common channel.

17. The network device of claim 16, wherein the indication is indicative of resources for performing communication by each of the set of identified active terminal devices respectively.

18. A method comprising:
receiving, at a terminal device from a network device in a radio access network, a configuration associated with a set of subcarriers, wherein the set of subcarriers are associated with a set of terminal devices in the radio access network for transmission of modulated signals, the modulated signals being indicative of activity information of a set of active terminal devices out of the set of terminal devices; and
transmitting, to the network device, a modulated signal, wherein the modulated signal is generated by modulating a subcarrier from the set of subcarriers with a symbol and the modulated signal comprises a sparse Multicarrier Faster Than Nyquist (MC-FTN) signaling.

19.-22. (canceled)
